(19) United States
(12) Patent Application Publication
(10) Pub. No.: US 2006/0255632 A1
(43) Pub. Date: Nov. 16, 2006

(54) Active headrest structure

(76) Inventor: Yousuke Sugimoto, Mexico-city (MX)

Correspondence Address: Leffert Jay & Polglaze P.A., P.O. Box 581009, Minneapolis, MN, 55458-1009, US

(21) Appl. No.: 11/408,626

(22) Filed: Apr. 21, 2006

(30) Foreign Application Priority Data
Apr. 22, 2005 (JP) 2005-125097

(51) Int. Cl. B60N 2/427; B60R 21/00; A47C 7/38; B60R 22/28

(52) U.S. Cl. 297/216.12; 297/408

(57) ABSTRACT

An active headrest structure that can be disposed without damaging the board member on the back surface of the seat back is provided. On the back surface of seat back 18 is provided backboard 20, which is approximately a board shape and disposed apart from arm member 4 in the front to rear direction of the vehicle. Top portion 20b of backboard member 20 and arm member 4 are connected by spring member 23 as the elastic member.

### CROSS-REFERENCE TO RELATED APPLICATIONS

The present application claims priority under 35 U.S.C. § 119 of Japanese Application No. 2005-125097, filed on Apr. 22, 2005, the entire content of which is expressly incorporated by reference herein.

### FIELD

The present invention pertains to an active headrest structure provided on a seat back that constitutes the seat of a vehicle, such as an automobile.

### BACKGROUND

Conventionally, a constitution for an active headrest structure is known in which a pressure-receiving member provided on an arm member is fastened to the seat back covering material, which is stretched over the back surface of the seat back, with a hook member. (See Unexamined Japanese Patent Application Publication No. 2004-106657)

When a load is applied from the front part of the vehicle to the pressure-receiving member, the headrest is turned toward the front part of the vehicle.

### SUMMARY

However, when the aforementioned conventional active headrest structure is applied to a seat equipped with a flat, board-shaped board member on the back surface of the seat back, the pressure-receiving member may interfere with the board member, resulting in possible damage to the board member when the active head rest mechanism operates causing the arm member to move toward the rear of the vehicle.

The purpose of the present invention is to provide an active headrest structure that can decrease the possible damage to the board member provided on the back surface of the seat back.

The present invention was contrived in light of the aforementioned circumstances, wherein the active headrest structure is comprised of a seat, seat back, a headrest disposed on the upper of the seat back, an arm member disposed on the back surface of the seat back, and an elastic member connecting the backboard member and the arm member. According to the present invention, under a normal state in which no load is applied to the arm member, the backboard member is positioned toward the front part of the vehicle.

When a load is applied to the arm member from the front part of the vehicle, the headrest is turned toward the front part of the vehicle while said arm member is rockably moved toward the rear part of the vehicle.

When this takes place, the load is transmitted to the backboard member from the front part of the vehicle by means of the elastic member and said backboard member is pressed in, causing the backboard member to be tilted back toward the rear of the vehicle with its lower portion.

### BRIEF DESCRIPTION OF DRAWINGS

FIG. 1 is a longitudinal section of the front seat for explaining the overall constitution of the active headrest structure for the embodiment of the present invention.

FIG. 2 is an enlarged cross section for explaining the constitution of the lower portion of the seat back of the active headrest structure for the embodiment of the present invention.

FIG. 3 is a longitudinal section of the front seat for explaining the situation with the active headrest mechanism when in operation for the active headrest structure for the embodiment of the present invention.

### DETAILED DESCRIPTION

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

Below is provided an explanation of the most favorable embodiment for enforcing the present invention with reference to the drawings.

The active headrest structure for the present embodiment is equipped with front seat 16 inside of passenger compartment 15 of the vehicle.

Front seat 16 consists of seat cushion 17 and seat back 18, and provided inside of seat back 18 is seat back frame member 3, which constitutes a metal pipe-shaped member. Additional details of the shape of the seat back frame member 3 are contained in U.S. Pat. No. 4,491,365.

In addition, seat back frame member 3 is equipped with rockably supported arm member 4 and arm member 4 is connected to leg 19, which is the headrest support member that supports headrest 5 that is equipped on top of seat back 18.

In addition, provided inside of seat back 18 is spring 13, of which one end is fastened to the seat back frame also provided in seat back 18, but not shown in the drawing, and the other end is fastened to arm member 4. Force is applied by spring 13 to arm member 4 to pull it toward the front part of the vehicle.

Thus, a constitution is achieved for a so-called active headrest mechanism wherein headrest 5 is turned toward the front part of the vehicle when a predetermined load or more is applied to arm member 4 from the front part of the vehicle when it crashes.

In addition, for the present embodiment, provided on the back surface of seat back 18 is backboard 20, which is approximately a flat, board shape and is disposed apart from arm member 4 in the front to rear direction of the vehicle.

On seat inner surface 20d of lower portion 20a of backboard member 20 is mounted clip member 21 so that it protrudes.

Wire member 22 is joined to clip member 21 so as to axially rotate around the seat back frame (not shown in the drawing) inside of seat back 18 and backboard member 20 is axially supported to the seat back frame so that it can move freely.

In addition, disposed as a single body on seat inner surface 20d of top portion 20b of backboard member 20 is semi-circular fastening ring portion 20c so as to face semi-circular arm fastening ring member 4a, which is formed as a single body on arm member 4.

Top portion 20b of backboard member 20 and arm member 4 are connected by spring member 23 as the elastic member.

In other words, one end of hook 23a of spring member 23 is fastened to fastening ring member 20c, while the other end of hook 23a of spring member 23 is fastened to arm fastening ring member 4a so that spring member 23 is suspended between them.

Therefore, under a normal state in which a load is not applied to arm member 4, backboard member 20 operates to apply a force in the vicinity of arm member 4 in the front to rear direction of the vehicle by means of spring member 23.

Next is provided an explanation of the operation of the present embodiment.

Under a normal state in which a load is not applied to arm member 4, backboard member 20 is forced toward the front part of the vehicle by means of spring member 23 and is positioned toward the front part of the vehicle, so knee space 10 can be secured between the back surface of front seat 16 and the back seat.

Then, as shown in FIG. 3, when a load is applied to arm member 4 from the front part of the vehicle, the lower portion of arm member 4 moves toward the rear of the vehicle and headrest 5 is turned toward the front part of the vehicle, as indicated by the solid line.

When this takes place, the load is transmitted to top portion 20b of backboard member 20 from the front part of the vehicle by spring member 23 and backboard member 20 is pressed in and turns at clip member 21 provided on lower portion 20a of backboard member 20 with wire member 22 as the center of movement.

Thus, top portion 20b of backboard member 20 is tilted back toward the rear of the vehicle.

Therefore, when the vehicle crashes, arm member 4 interferes with backboard member 20, which has moved toward the rear of the vehicle, and damage to backboard member 20 can be mitigated.

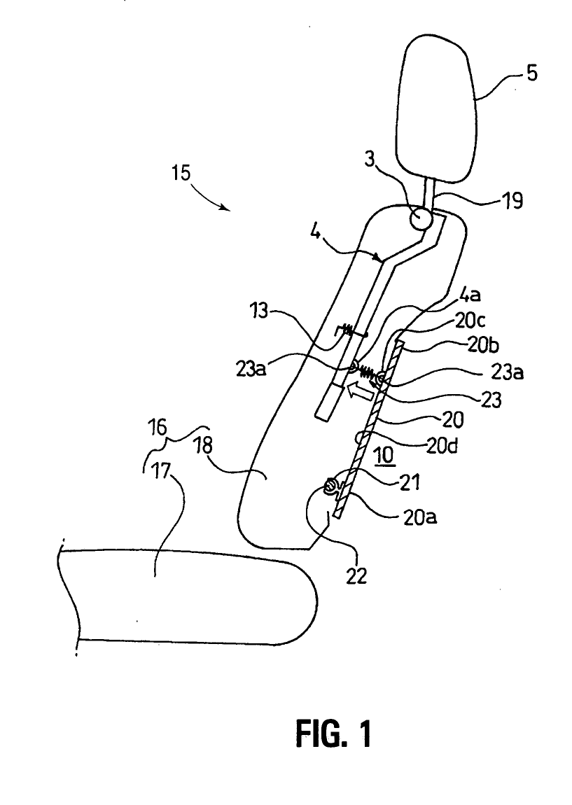

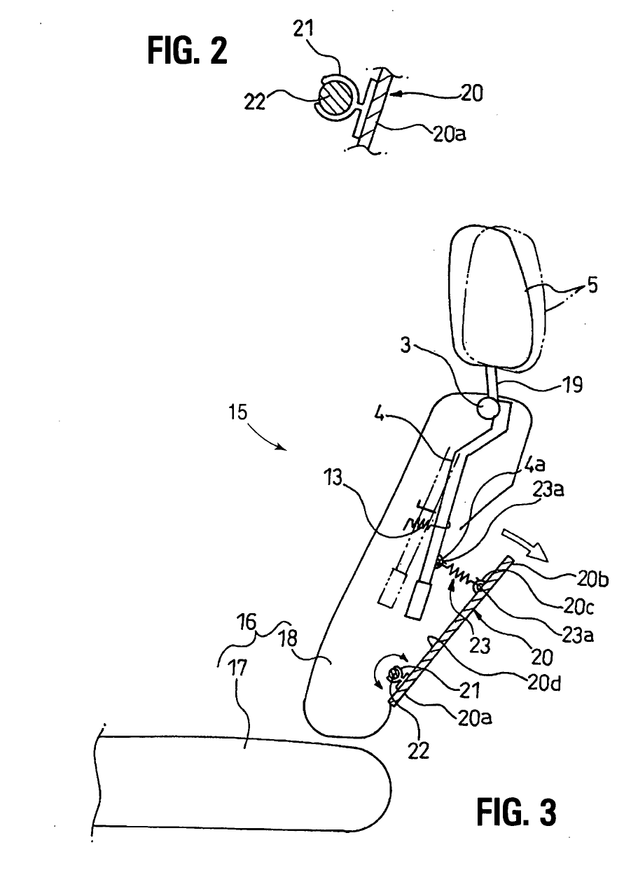

In addition, for the present embodiment, under a normal state, backboard member 20 is forced in toward the front part of the vehicle by spring member 23, as shown in FIG. 1.

Therefore, when a passenger's head rests on headrest 5 or the passenger is seated deeply into front seat 16, even if arm member 4 rocks in the front to rear direction of the vehicle under a normal range of use, spring member 23 expands and contracts, making it difficult for the load to get transmitted to backboard member 20 and the tilting of backboard member 20 toward the rear of the vehicle can be mitigated.

In addition, even if a relatively small load is applied to knee space 10 of backboard member 20 toward the front direction of the vehicle, such as when the knees of a passenger seated in the back seat come into contact with the backboard, the movement of backboard member 20 toward the front part of the vehicle can be prevented from getting transmitted to arm member 4 due to the contraction of spring member 23 and the rocking of headrest 5 can be mitigated, resulting in a better quality application of the headrest.

Furthermore, since top portion 20b of backboard member 20 and arm member 4 are connected via spring member 23, the number of parts required can be reduced and an increase in manufacturing costs can be curtailed, compared to when a linking member is used to connect them, and strange noises caused by loose parts can be mitigated, resulting in quieter operation.

In this manner, since the movement of arm member 4 is not hindered, the operation of the active headrest mechanism can be carried out smoothly.

A detailed explanation has been provided above for an embodiment of the present invention with reference to the drawings, but the concrete constitution is not restricted to this embodiment or any embodiment and changes in the design can be included in the present invention as long as they do not deviate from the contents of the present invention.

In other words, for the active headrest structure for Embodiment 1, an explanation was provided using aforementioned spring member 23 for the elastic member, but the present invention is not necessarily restricted to such a member and top portion 20b of backboard member 20 and arm member 4 can be connected by using rubber or the like that can be elastically deformed for the elastic member and there is no particular restriction as to the shape, amount, or material used for the elastic member.

What is claimed is:

1. An active headrest structure comprising:
a seat back frame member;
an arm member rockably supported to the seat back frame member;
a headrest support member connected to the arm member;
a headrest connected to and supported by the headrest support member; and
a backboard member disposed on the back surface of said seat back apart from the arm member, the backboard member rockably supported to the seat back frame member with the lower portion of the backboard member, and
an elastic member connecting the top of the backboard member and the arm member.

2. The active headrest structure of claim 1, wherein the backboard member is forced by the elastic member toward the front part of the vehicle when in a normal state.

3. The active headrest structure of claim 2, wherein the elastic member is rubber that can be elastically deformed.

4. The active headrest structure of claim 1, wherein the elastic member is rubber that can be elastically deformed.

5. The active headrest structure of claim 1, wherein the elastic member is a spring member.

6. The active headrest structure of claim 2, wherein the elastic member is a spring member.

7. A seat structure having an active headrest mechanism, comprising:
a seat;
a seat back;
a headrest disposed on the upper portion of the seat back;
an arm member disposed inside of the seat back;
a headrest support member that supports the headrest;
a backboard member disposed on the back surface of the seat back, the backboard member rockably supported to the seat back frame member with the lower portion of the backboard member;
an elastic member connecting the backboard member and the arm member; and
wherein the arm member is rockably supported via the headrest support member so that the headrest is turned toward the front part of the seat when a load is applied from the front.

8. The active headrest structure of claim 7, wherein the backboard member is forced by the elastic member toward the front part of the vehicle when in a normal state.

9. The active headrest structure of claim 8, wherein the elastic member is rubber that can be elastically deformed.

10. The active headrest structure of claim 7, wherein the elastic member is rubber that can be elastically deformed.

11. The active headrest structure of claim 7, wherein the elastic member is a spring member.

12. The active headrest structure of claim 8, wherein the elastic member is a spring member.

13. A method of operating an active headrest structure, comprising:
turning a headrest mounted above a seat toward a front of a vehicle when a load is applied from the front of the vehicle; and
turning a backboard mounted to a back of the seat toward a rear of the vehicle when a load is applied from the front of the vehicle.

14. The method of claim 13, wherein turning the headrest comprises:
supporting the headrest on an arm member rockably supported to a seat frame back member; and
turning the headrest toward the front of the vehicle when a load is applied to the arm member from the front.

15. The method of claim 13, wherein turning the backboard comprises:
rotatably connecting the backboard at one end to the seat back;
connecting the backboard and the arm member with an elastic member; and
turning the backboard toward the rear of the vehicle when a load is applied to the arm member from the front.

16. The method of claim 13, wherein:
turning the headrest comprises:
supporting the headrest on an arm member rockably supported to a seat frame back member; and
turning the headrest toward the front of the vehicle when a load is applied to the arm member from the front; and wherein:
turning the backboard comprises:
rotatably connecting the backboard at one end to the seat back;
connecting the backboard and the arm member with an elastic member; and
turning the backboard toward the rear of the vehicle when a load is applied to the arm member from the front.

17. An active headrest structure, comprising:
means for turning a headrest mounted above a seat toward a front of a vehicle when a load is applied from the front of the vehicle; and
means for turning a backboard mounted to a back of the seat toward a rear of the vehicle when a load is applied from the front of the vehicle.

18. The active headrest structure of claim 17, wherein the means for turning the headrest comprises:
means for supporting the headrest on an arm member rockably supported to a seat frame back member; and
means for turning the headrest toward the front of the vehicle when a load is applied to the arm member from the front.

19. The active headrest structure of claim 17, wherein the means for turning the backboard comprises:
means for rotatably connecting the backboard at one end to the seat back;
means for connecting the backboard and the arm member with an elastic member; and
means for turning the backboard toward the rear of the vehicle when a load is applied to the arm member from the front.
